(19) United States
(12) Patent Application Publication
(10) Pub. No.: US 2017/0261353 A1
(43) Pub. Date: Sep. 14, 2017

(54) SUPPORT FOR A SENSOR ELEMENT, ASSEMBLY, AND ROTATIONAL SPEED SENSOR

(71) Applicant: WABCO GmbH, Hannover (DE)

(72) Inventors: Oliver GRÜNDKER, Wedemark (DE); Andre KORCZOWSKI, Barsinghausen (DE); Tobias KORTLANG, Gehrden (DE); Sebastian KOSS, Hannover (DE); Stefan NIEBER, Garbsen (DE)

(21) Appl. No.: 15/509,370

(22) PCT Filed: Aug. 7, 2015
(86) PCT No.: PCT/EP2015/001634

§ 371 Date: Mar. 7, 2017

(30) Foreign Application Priority Data
Sep. 8, 2014 (DE) 10 2014 013 356.7

(51) Int. Cl. G01D 11/24

(52) U.S. Cl. CPC G01D 11/245; G01D 5/142

(57) ABSTRACT

Disclosed is a support (10) for a sensor element (11). The support (10) is for potting and manufacturing a rotational speed sensor. The support (10) comprises an at least partially hollow body for accommodating electric contacts and a potting compound. According to the invention, a cover (25) is provided for covering and filling a recess defined by the at least partially hollow body.

### CROSS-REFERENCE TO RELATED APPLICATIONS

This application is the National Stage of International Application No. PCT/EP2015/001634, filed on 7 Aug. 2015, which claims priority to and all advantages of German Patent Application No. 10 2014 013 356.7, filed on 8 Sep. 2014, the content of which is hereby incorporated by reference.

### FIELD OF THE INVENTION

The invention generally relates to a support and, more specifically, to a support for a sensor element, an assembly including the same, and to a rotational speed sensor.

### BACKGROUND OF THE INVENTION

Active rotational-speed sensors for motor vehicles or other applications may exhibit a Hall sensor by way of sensor element. Such a Hall sensor is also designated as a Hall IC and interacts with a pulse wheel. Depending on the type of construction, the pulse wheel is a magnetic multipole wheel or a toothed wheel that is not magnetized. In the latter case, a permanent magnet is assigned to the Hall sensor. An active wheel-speed sensor with Hall sensor element with permanent magnet and punched ring by way of pulse transmitter is disclosed in WO 2011/012399 A1.

The operation of the sensor element can easily be impaired by dust, dirt and moisture. The sensor element may therefore have been completely encapsulated by an injection-molding compound, see DE 10 2009 008 457 A1.

In the course of encapsulation a defined position of the sensor element and, where appropriate, of the permanent magnet has to be guaranteed. For this purpose it is known to hold the sensor element or the permanent magnet in a support, see KR 20110057455 (A).

The sensor element exhibits electrical contacts which in the region of the support have to be connected to contact wires of electrical leads. A connecting region of electrical contacts and contact wires has to be accessible for the connection of the same. The support exhibits apertures or recesses for this purpose.

A relatively large amount of injection-molding compound has to be supplied through the apertures and recesses in the course of encapsulating the support and the sensor element. Associated with this are a high influx of thermal energy and also the risk of impairments of the components that are present in the course of encapsulation and/or in the course of the subsequent cooling of the injection-molding compound.

### SUMMARY OF THE INVENTION

The present invention provides a support that is particularly well suited for encapsulation with an injection-molding compound.

The support according to the invention comprises an at least partially hollow body for receiving electric contacts and a potting compound. The support further comprises a cover for covering and filling out a recess defined by the body. The existing recess of the body is at least partially filled out by the cover. By virtue of this measure, the injection-molding compound to be injected into the support altogether and the resulting thermal loading can be distinctly reduced. The cover may also have been adapted to the external shape of the support, so that the external surface of the support becomes more uniform by virtue of the cover than without the cover. Greatly differing cross sections and thicknesses of the injection-molding compound are avoided by virtue of the cover.

In certain embodiments, the body exhibits a substantially cylindrical basic shape. At the same time, the cover can be inserted into the recess along a part of a radially exterior side. In this way, the cover complements the cylindrical basic shape and contributes to filling it out.

In these or other embodiments, the body is of elongated design, and that the recess is located along a part of a longitudinal side. In particular, the cover and the recess each exhibit a length that corresponds to approximately one half of the length of the body. In this way, the recess has been dimensioned sufficiently to enable access to the electrical contacts during production. The cover fills out the contour of the recess—also in the direction toward the contacts—as far as possible.

The depth of the recess typically corresponds to approximately one half of the thickness of the body. The same typically applies to the cover, though the latter may also exhibit a somewhat smaller depth.

In certain embodiments, the cover exhibits an external surface, and that the body defines an outlet aperture for the potting compound, the outlet aperture of the body and the external surface of the cover being designed and arranged relative to one another in such a way that the potting compound emerging from the outlet aperture presses against the external surface of the cover. In the course of the supply of the injection-molding compound into the support, some of it emerges from the outlet aperture, presses against the external surface, and in this way holds the cover securely in its closed position. As a result, it is guaranteed that the cover will not be lifted by the flowing injection-molding compound.

In various embodiments, the external surface extends, at least partially, obliquely with respect to a longitudinal extent of the body or of the cover. Opposite the external surface the cover may exhibit a detent element which holds the cover securely. The detent element then acts at one end of the cover, and the injection-molding compound applied to the external surface acts at the other end.

In certain embodiments, the body is of elongated design and in the region of a front side exhibits an inlet aperture for the potting compound. The inlet aperture is typically connected to the aforementioned outlet aperture or is arranged adjacent thereto. The outlet aperture has then also been provided close to the front side.

In various embodiments, the cover and/or the body exhibit(s) surfaces with elevations directed radially outward. In this case it is typically a question of burls, spigots or lugs for centering in a mold in the course of potting. At the same time, the elevations have the effect of spacers from insides of the mold. As a result, after the potting all the external surfaces of the body and the cover have been covered with the potting compound, where appropriate apart from front faces or external surfaces of the elevations.

In certain embodiments, the body exhibits at least one aperture for access to the electrical contacts, in particular to the contacts to be connected to one another. The aperture is typically an aperture situated opposite the recess of the body. Without a cover, the contacts are accessible from two sides, namely through the aperture, on the one side, and through the recess, on the other side.

In various embodiments, the body is of elongated design. At the same time, a receptacle for a sensor element has been provided in the region of a front side. Moreover, a partition may have been provided between the receptacle and the body, in particular with a passage for the potting compound. By virtue of the partition, the thermal loading of the sensor element in the course of potting is reduced.

The invention also provides an assembly, in particular for producing a rotational-speed sensor, with at least one sensor element and with a support according to the invention. The support and the sensor element have typically already been potted together.

Finally, the invention also provides a rotational-speed sensor, with a support according to the invention and with a sensor element, the support and the sensor element having been potted together. A rotational-speed sensor designed in such a manner can be produced inexpensively and is reliable in application.

### BRIEF DESCRIPTION OF THE DRAWINGS

Further features of the invention will become apparent from the description in other respects, and from the claims. Advantageous exemplary embodiments of the invention will be elucidated in more detail in the following on the basis of drawings, in which:

FIG. 1 shows a representation of various stages in the production of a rotational-speed sensor,

FIG. 2 shows a support with raised cover in a side view;

FIG. 3 shows the support with cover according to FIG. 2 in a front view,

FIG. 4 shows the support with cover according to FIG. 2 in perspective representation,

FIG. 5 shows the support with cover according to FIG. 2 in a radial top view,

FIG. 6 shows the support with attached cover in a side view,

FIG. 7 shows the support with attached cover according to FIG. 6 in a radial top view,

FIG. 8 shows the support with cover according to FIG. 6 in perspective representation,

FIG. 9 shows a support with raised cover in side view, similar to FIG. 2 but with differently configured cover,

FIG. 10 shows the finished rotational-speed sensor in a representation analogous to FIG. 9, namely with cover sketched radially outside and with representation of the direction of flow of the material in the course of hypothetical potting of the support without cover, and

FIG. 11 shows a representation corresponding to FIG. 10, but with inserted cover, with representation of the direction of flow of the material in the course of potting of the support.

### DETAILED DESCRIPTION

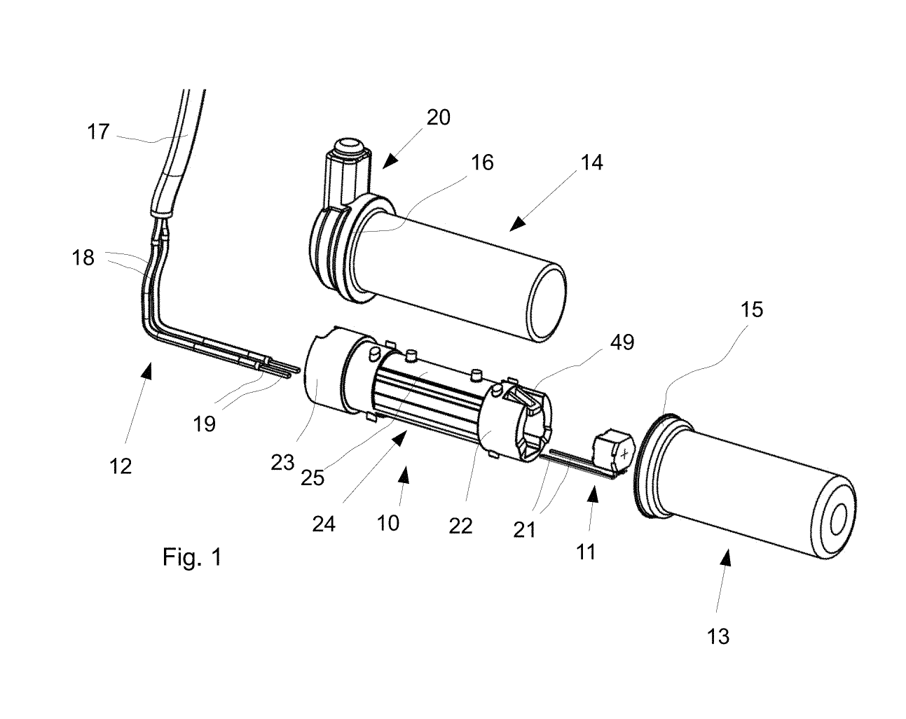

In FIG. 1, various components and manufacturing stages of a complete rotational-speed sensor can be discerned. Inside the rotational-speed sensor, a support 10 with sensor element 11 and connecting lead 12 has been provided. An external casing of the rotational-speed sensor is formed by a metal cylinder 13 which is open on one side.

Above the stated parts 10, 11 a further cylindrical part 14 is visible. It is a question of the support 10 at a certain stage of manufacture, namely surrounded by the potting compound and after removal from an injection mold. The metal cylinder 13 is pushed over part 14, so that a circumferential collar 15 of the metal cylinder 13 extends over a circumferential shoulder 16 of part 14. For the purpose of sealing, an O-ring (not shown) has been provided under the collar 15.

The connecting lead 12 consists here of at least three different portions, namely a cable 17, two conductors 18 and two conductor contacts 19. Part 16 exhibits at one end an elbow 20, into which the connecting lead 12 has been potted. Part 14, however, has been drawn in FIG. 1 without the connecting lead 12. In fact, only the cable 17 protrudes upward out of the elbow 20.

The sensor element 11 has been provided with sensor contacts 21 which have been electrically connected in the support 10 to the conductor contacts 19.

The support 10 comprises a partially hollow body and exhibits an elongated, cylindrical basic shape, with a front region 22 for receiving the sensor element 11, with an opposing front region 23 for entry of the connecting lead 12, with a central region 24 of reduced thickness, and with a cover 25 abutting the central region 24. The cover compensates for the smaller thickness of the central region 24 and is situated, just like the central region 24, between the two front regions 22, 23. The combination of cover 25 and central region 24 exhibits a somewhat smaller cross section or outer perimeter than the two front regions 22, 23.

FIG. 3 shows the front view of front region 22 for receiving the sensor element 11.

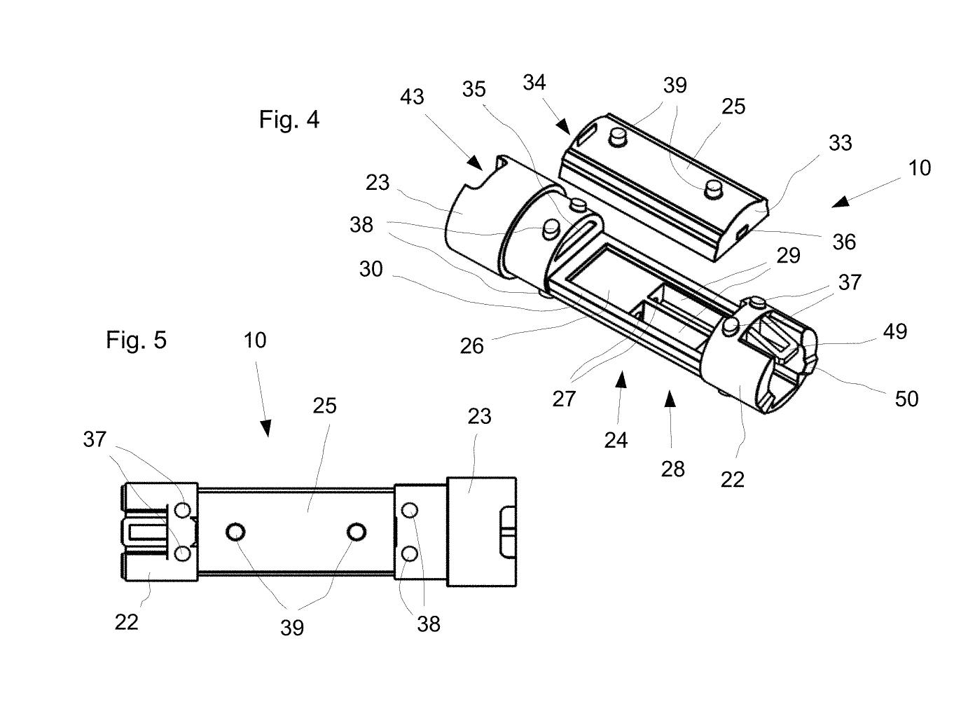

The central region 24 is shown in greater detail in FIG. 4. Discernible are a partly solid region 26, adjacent to front region 23 and with two parallel channels extending in the longitudinal direction, the apertures 27 of which are visible in FIG. 4. The conductors 18 are guided in the channels.

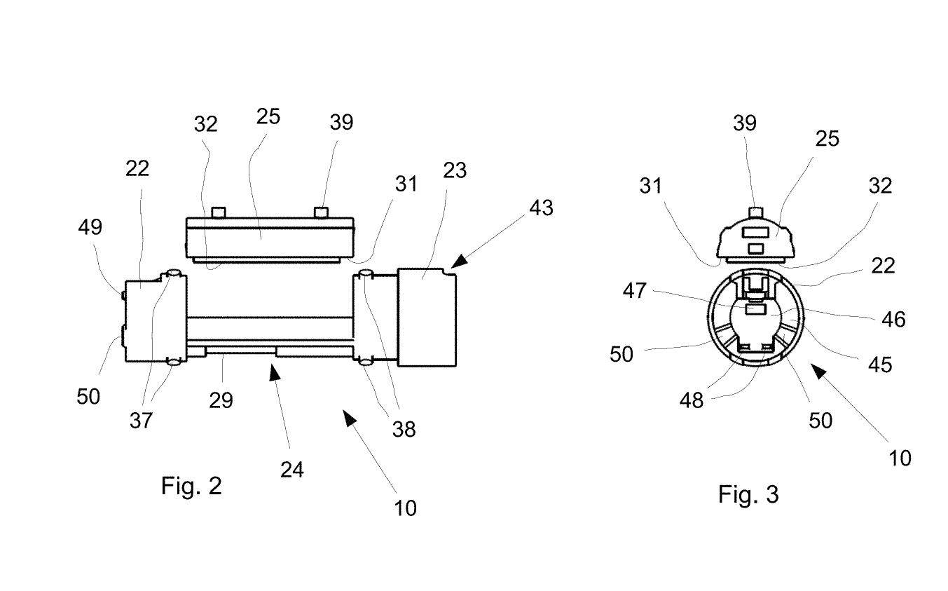

Between region 26 and front region 22 the central region 24 exhibits, in addition, a window region 28, with two windows 29 extending parallel to one another. The stated channels with the apertures 27 lead laterally into the windows 29. The windows 29 are permeable at right angles to the longitudinal direction or, to be more exact, in the radial direction of the support 24. In the region of the windows 29, contacts 19 are connected to contacts 21 in overlapping manner. By virtue of the arrangement of the windows 29, it is possible to machine the contacts 19, 21 inserted into the support 24 for the purpose of connecting the contacts, for example to solder them together, in the view of FIG. 2 from above and from below.

The central section 24 exhibits in a longitudinally-directed plane a circumferential frame 30 on which the cover 25 comes to be situated in a closed position. For this purpose the cover 25 may exhibit on its underside a circumferential shoulder 31—see, in particular, FIG. 2. The shoulder 31 is bounded inwardly by a projection 32 which can be inserted into the frame 30 in fitting manner. As a result, the cover 25 has been positioned unambiguously on the support 24.

On its front sides 33, 34 the cover 25 may exhibit detent elements which interact with detent elements, not shown, of the front regions 22, 23 of the support 24.

Channels, not shown, for the transmission of the potting compound may have been provided in the cover 25. Discernible in FIG. 4 are a cover-side outlet aperture 35 in front region 23 and an outlet aperture 36 on front side 33. Outlet apertures directed toward the support 24 may also have been provided on the cover 25, in particular so as to correspond to the windows 29.

On its front regions 22, 23 the support 10 exhibits elevations directed radially outward, namely burls 37, 38. In the present exemplary embodiment, each front region 22, 23 exhibits circumferentially four burls 37 and 38, respectively. Analogously thereto, the cover 25 has been provided on its upper side with burls 39 which follow one another in the longitudinal direction of the support 10.

The burls 37, 38, 39 bring about a centering of the support 10 in the course of the potting in the mold which is not shown. At the same time, it is ensured by the burls 39 that the cover 25 does not lift off in the course of potting.

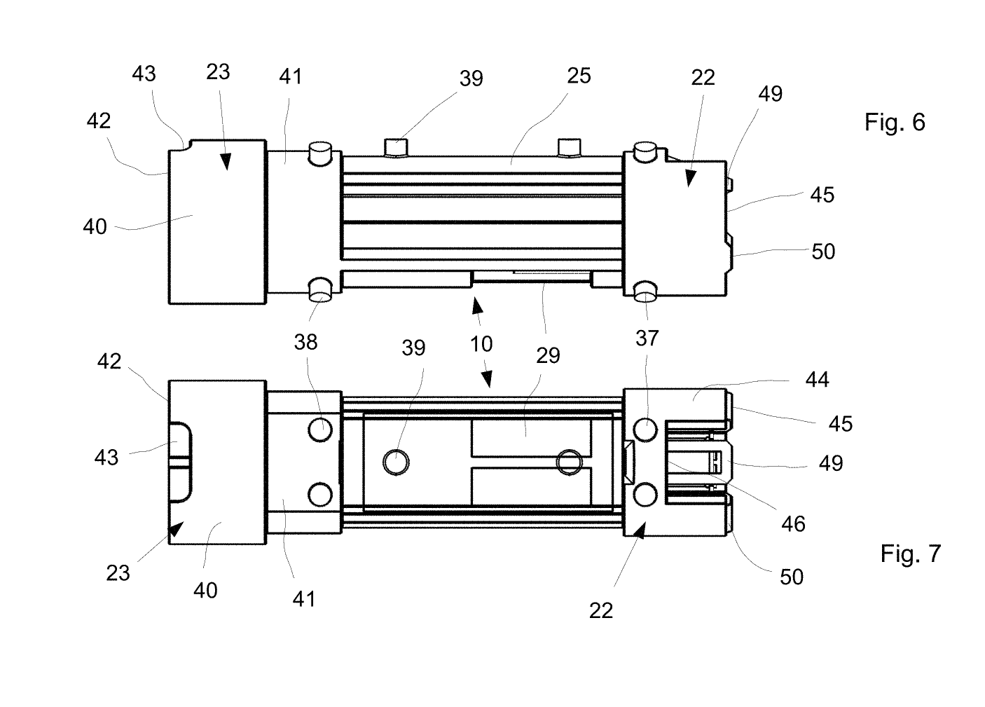

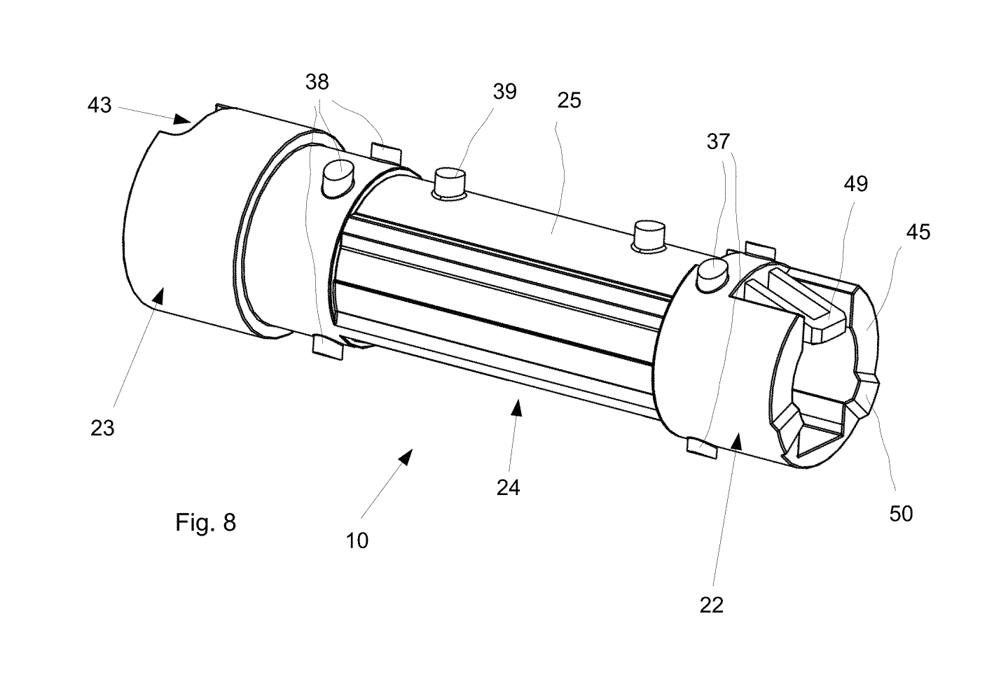

Front region 23 for the connecting lead 12 is bipartite. A frontal end 40 exhibits a somewhat larger diameter than a portion 41 directed toward the central region 24; see, in particular, FIGS. 6 and 7. The end 40 exhibits on its front side 42 at the edge a depression 43 for entry of the connecting lead 12. In addition, apertures, not shown, may have been provided for the entry of the potting compound, in particular so as to correspond to the outlet aperture 35.

Front region 22 is substantially of pot-like design with a thick circumferential wall 44, with a circumferential front face 45 of the wall 44, and with a partition 46 with respect to the central region 24; see FIG. 3. The partition 46 may have been provided with an aperture 47 for the 2 5 passage of the potting compound, and with channel apertures 48 for the passage of contacts 21.

The circumferential wall 44 is interrupted by a resilient detent element 49—see, in particular, FIG. 7—with which the sensor element 11 inserted into front region 22 is held there.

Elevations 50 may have been provided on the circumferential front face 45. The elevations act, like the burls 37, 38, 39, in centering manner and/or for the purpose of guiding the potting compound in the course of potting.

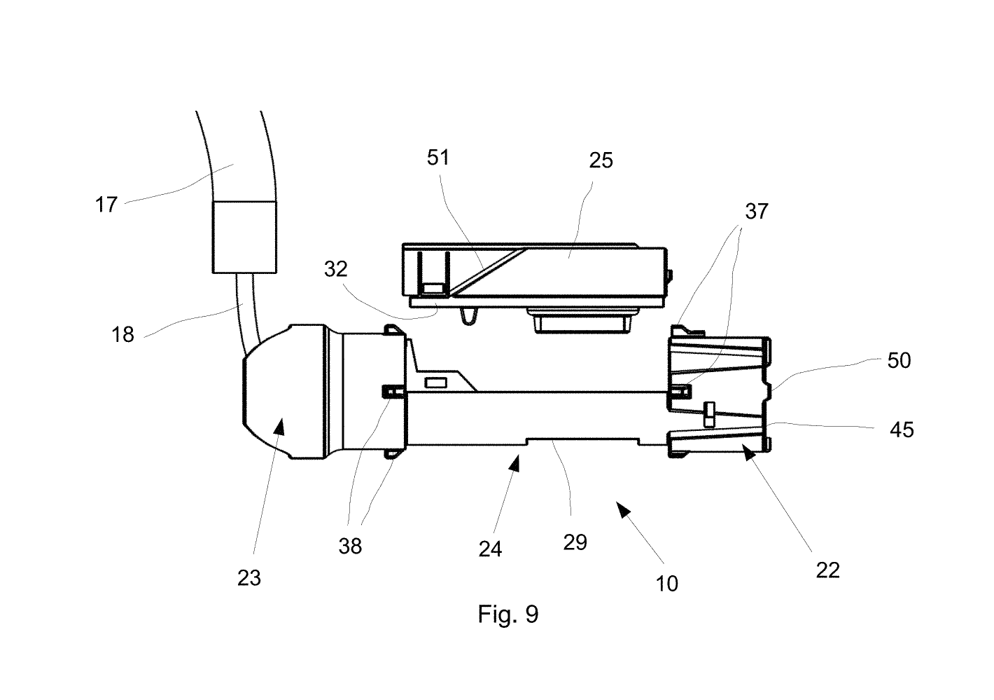

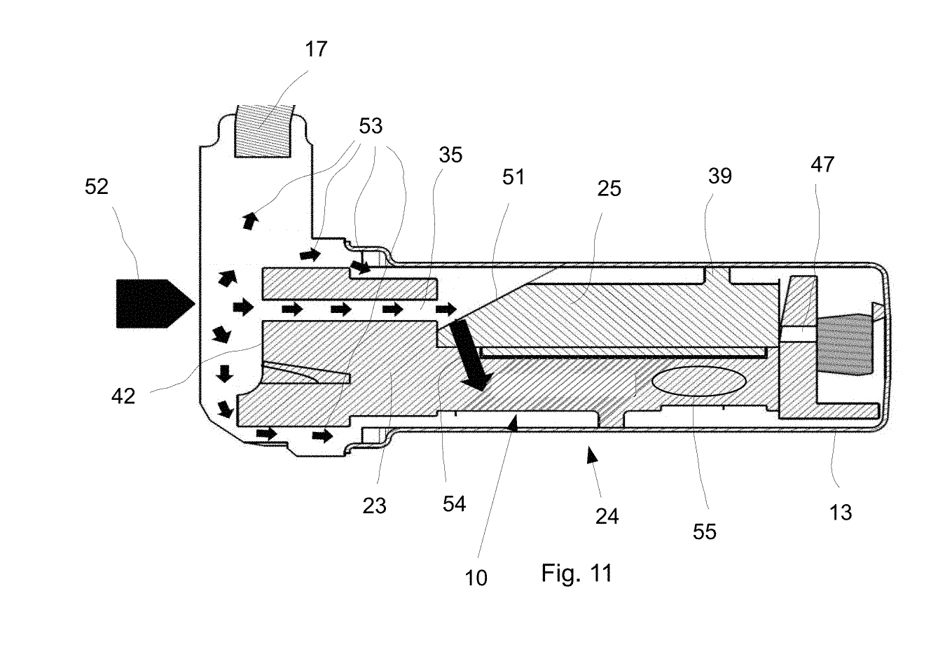

FIGS. 9 to 11 show a modified embodiment of the support 10 and the cover 25. The cover 25 here has been provided with an oblique external surface 51 which is subjected to incident flow of the potting material in the course of potting (in the injection-molding process); see, in particular, FIG. 11. With respect to a longitudinal axis of the support 10 the oblique external surface 51 exhibits an angle of approximately 30 degrees and faces toward the outlet aperture 35. The potted support 10 in the metal cylinder 13 is shown in FIG. 11. A thick arrow 52 points in the longitudinal direction toward front side 42 and indicates from which direction and at which point the potting compound was injected into the mold, which is not represented in any detail. The many small black arrows 53 illustrate the path of the potting compound through front region 23. A long, narrow arrow 54 points from the oblique external surface 51 to the central region 24 and illustrates the location and direction of the force acting on the cover 25 by virtue of the flowing potting compound.

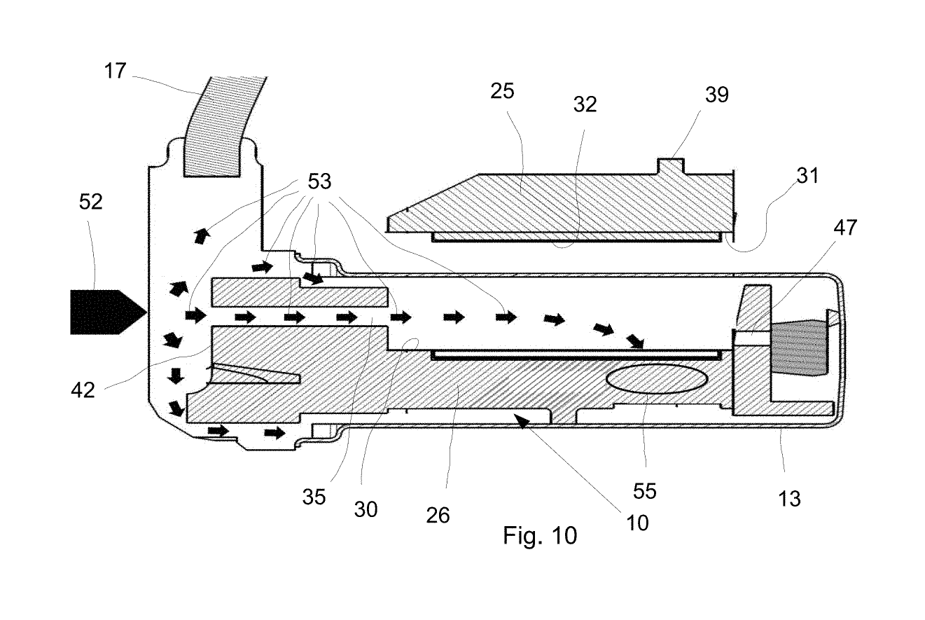

FIG. 10 shows, purely hypothetically for the purpose of clarification on the basis of arrows 53, the flow of the potting compound if no cover were attached. In this case, the potting compound would arrive directly through the windows 29 at a connecting region 55 of the contacts 19, 21 and would subject the contacts to a relatively high pressure from above, with higher pressure than from below. The connection can be impaired thereby. In the connecting region 55 a low pressure and a low rate of flow are striven for. This too is obtained by virtue of the cover 25 and the configuration thereof described with reference to the figures.

What is claimed is:

1. A support for a sensor element to produce a rotational-speed sensor, said support comprising an at least partially hollow body for receiving electrical contacts and a potting compound, and further comprising a cover for covering and filling out a recess defined by the at least partially hollow body.

2. The support as claimed in claim 1, wherein the body exhibits a substantially cylindrical shape, and wherein the cover can be inserted into the recess along a part of a radially exterior side of the support.

3. The support as claimed in claim 1, wherein the body has an elongated design, and wherein the recess is defined along a part of a longitudinal side of the support.

4. The support as claimed in claim 1, wherein the cover exhibits an external surface, and wherein the body defines an outlet aperture for the potting compound, said outlet aperture and said external surface being arranged relative to one another in such a way that the potting compound emerging from the outlet aperture presses against the external surface of the cover.

5. The support as claimed in claim 4, wherein the external surface extends, at least partially, obliquely with respect to a longitudinal extent of the body or of the cover.

6. The support as claimed in claim 1, wherein the body is of elongated design and in the region of a front side defines an inlet aperture for the potting compound.

7. The support as claimed in claim 1, wherein the cover and/or the body exhibit(s) surfaces with elevations directed radially outward.

8. The support as claimed in claim 1, wherein the body defines at least one aperture for access to the electrical contacts.

9. The support as claimed in claim 1, wherein the body is of elongated design, and a receptacle for the sensor element is located in a front region of the body.

10. An assembly for producing a rotational-speed sensor, with at least one sensor element and with a support as claimed in claim 1.

11. A rotational-speed sensor, with a support as claimed in claim 1 and with a sensor element, said support and said sensor element having been potted together.

12. The support as claimed in claim 7, wherein the cover and/or the body exhibit(s) surfaces with burls.

13. The support as claimed in claim 9, further comprising a partition between the receptacle and the body, the partition defining a passage for the potting compound.
